(19) United States
(12) Patent Application Publication
(10) Pub. No.: US 2014/0045065 A1
(43) Pub. Date: Feb. 13, 2014

(54) LI-ION BATTERY ELECTRODES HAVING NANOPARTICLES IN A CONDUCTIVE POLYMER MATRIX

(71) Applicants: Nanjing University, Nanjing (CN); The Board of Trustees of the Leland Stanford Junior University, Palo Alto, CA (US)

(72) Inventors: Zhenan Bao, Stanford, CA (US); Yi Cui, Stanford, CA (US); Hui Wu, Mountain View, CA (US); Guihua Yu, Mountain View, CA (US); Lijia Pan, Nanjing (CN)

(21) Appl. No.: 13/963,414

(22) Filed: Aug. 9, 2013

Related U.S. Application Data
(60) Provisional application No. 61/681,395, filed on Aug. 9, 2012.
(60) Provisional application No. 61/785,333, filed on Mar. 14, 2013.

(51) Int. Cl. H01M 4/62; H01M 4/04

(52) U.S. Cl. CPC H01M 4/622; H01M 4/043
USPC 429/217; 252/500

(57) ABSTRACT

Aspects of the present disclosure are directed towards energy storage devices, and methods of manufacturing such devices. Energy storage devices, consistent with the present disclosure, include a source of lithium ions, a plurality of nanoparticles, and a conductive polymer network. The nanoparticles are encapsulated in conductive polymer shells and volumetrically change due to lithiation and delithiation due to movement of the lithium ions created by an electrical potential. The conductive polymer network bonds to the nanoparticles and accommodates volumetric changes of the plurality of nanoparticles during lithiation and delithiation.

### FEDERALLY-SPONSORED RESEARCH AND DEVELOPMENT

This invention was made with Government support under contract DE-AC02-76SF00515 awarded by the Department of Energy. The Government has certain rights in this invention.

### FIELD OF THE INVENTION

The invention pertains to lithium-based energy storage devices.

### BACKGROUND

Developing rechargeable lithium ion batteries with high energy density and long cycle life is of relatively-high importance to address the ever-increasing energy storage needs for various technological applications, including portable electronics, hybrid and electric vehicles, and grid-scale energy storage systems. Graphite, an anode material used in lithium ion batteries, has a theoretical capacity of ˜370 mAh/g. As such, this use of Graphite cannot fulfill new requirements for future electric vehicles which require both high energy density and long cycle life. Silicon (Si) has been proposed as an alternative anode material for Li-ion batteries. However, several scientific and technical challenges remain unsolved, hence hindering practical applications of Si-based electrodes.

### SUMMARY

Various aspects of the present disclosure are directed toward energy storage devices, apparatuses, and methods of making and using such energy storage devices and apparatuses. Certain embodiments of energy storage devices of the present disclosure include a source of lithium ions. Energy storage devices consistent with aspects of the present disclosure also include a plurality of nanoparticles encapsulated, each of which is encapsulated in conductive polymer shells. The nanoparticles volumetrically change due to lithiation and delithiation based on the movement of the lithium ions created by an electrical potential. Further, energy storage devices of the present disclosure include a conductive polymer network to bond the nanoparticles and to accommodate volumetric changes of the nanoparticles during lithiation and delithiation.

Various aspects of the present disclosure are also directed toward energy storage devices that include a source of lithium ions, and at least one electrode that maintains at least an 80% charge capacity after a number of charging cycles that extends into the thousands. For example, in certain embodiments, this charge capacity is effective after more than 500 charging cycles and in other embodiments, more than 2000 charging cycles and 5000 charging cycles, respectively. The electrode includes a plurality of nanoparticles, each of which are encapsulated in conductive polymer shells. The material of the conductive polymer shell includes at least one of polyaniline (PANi), polypyrrole (PPY) and PEDOT. Additionally, the nanoparticles volumetrically change due to lithiation and delithiation as a result of movement of the lithium ions created by an electrical potential. The electrode also includes a conductive polymer network of at least one of polyaniline (PANi) and polypyrrole (PPY) and PEDOT. In certain embodiments, a conductive filler, such as carbon nanotubes, graphene, carbon nano begs, metal particles or metal nano or microwires, is added into the conductive matrix. The conductive polymer network bonds the nanoparticles and accommodates volumetric changes of the plurality of nanoparticles during lithiation and delithiation.

Various aspects of the present disclosure are also directed towards methods of use and manufacturing. For instance, various methods include providing an anode for an energy storage device via solution phase synthesis which includes: synthesizing a conductive polymer network, encapsulating nanoparticles in conductive polymer shells and bonding the nanoparticles to the conductive polymer network. Other methods of the present disclosure include providing an anode for an energy storage device via solution phase synthesis. This solid phase synthesis includes synthesizing a conductive polymer network, encapsulating nanoparticles in conductive polymer shells and bonding the nanoparticles to the conductive polymer network. In certain embodiments of methods of the present disclosure, the energy storage device maintains an 80% charge capacity after 500 charging cycles.

Various aspects of the present disclosure are also directed towards methods that include wrapping nanoparticles with a conductive polymer matrix (e.g., nanostructured polyaniline (PANi)) to form a viscous gel, and providing the viscous gel on an electrode surface. In certain instances, these methods can also include mechanically pressing the viscous gel on an electrode surface. Additionally, certain methods of the present disclosure can include a step of forming the conductive polymer matrix by in-situ polymerization.

The above summary is not intended to describe each embodiment or every implementation of the present disclosure. The figures, detailed description and claims that follow more particularly exemplify various embodiments.

### BRIEF DESCRIPTION OF THE DRAWINGS

Aspects of the present disclosure may be more completely understood in consideration of the detailed description of various embodiments of the present disclosure that follows in connection with the accompanying drawings, in which:

FIG. 1 shows an example schematic illustration of 3D porous nanoparticle/conductive polymer hydrogel composite electrodes, consistent with various aspects of the present disclosure;

FIG. 2A shows an example step in an electrode fabrication process in which Si nanoparticles are dispersed in the hydrogel precursor solution, consistent with various aspects of the present disclosure;

FIG. 2B shows an example step in an electrode fabrication process in which a viscous gel is formed, consistent with various aspects of the present disclosure;

FIG. 2C shows an example step in an electrode fabrication process in which the viscous gel shown in FIG. 2B is bladed onto copper foil and dried, consistent with various aspects of the present disclosure;

FIG. 3A shows example cyclic voltammetry (CV) measurements of a SiNP-PANi hydrogel composite and polyaniline (PANi) hydrogel, consistent with various aspects of the present disclosure;

FIG. 3B shows an example electrochemical cycling performance of the in-situ polymerized SiNP-PANi composite electrodes under deep charge/discharge cycles compared to two control samples, consistent with various aspects of the present disclosure;

FIG. 3C shows an example capacity of an Si nanoparticle/conductive polymer hydrogel composite electrodes over 70 varying charge/discharge cycles, consistent with various aspects of the present disclosure;

FIG. 3D shows an example of Galvanostatic charge/discharge profiles of a SiNP-PANi electrode cycled at various rates from C/6 to 3 C, consistent with various aspects of the present disclosure;

FIG. 3E shows example graphs of Lithiation/delithiation capacity and CE of a SiNP-PANi electrode cycled at 10 C for 5,000 cycles, consistent with various aspects of the present disclosure;

FIG. 3F shows example Galvanostatic charge/discharge profiles plotted for the 1^{st}, 1,000^{th}, 2,000^{th}, 3,000^{th} and 4,000^{th} cycles, consistent with various aspects of the present disclosure;

FIG. 4 shows an example voltage profile of the first charge/discharge galvanostatic cycle of a SiNP-PANi composite electrode at a slow rate of C/5, consistent with various aspects of the present disclosure;

FIG. 5A shows an example scanning electron microscope (SEM) image of pure Si nanoparticles, consistent with various aspects of the present disclosure;

FIG. 5B shows an example SEM image of a polyaniline (PANi) hydrogel sample, consistent with various aspects of the present disclosure;

FIG. 5C shows an example SEM image of a SiNP-PANi composite electrode at low and high magnifications, consistent with various aspects of the present disclosure;

FIG. 5D shows an example tunneling electron microscope (TEM) image showing Si nanoparticles coated with a uniform polyaniline (PANi) polymer layer, consistent with various aspects of the present disclosure;

FIG. 5E shows an example TEM image showing Si nanoparticles coated with a uniform PANi polymer layer, consistent with various aspects of the present disclosure;

FIG. 6 shows an example series of SEM images of a Si nanoparticle electrode with PVDF binder after 2,000 cycles, consistent with various aspects of the present disclosure;

FIG. 7A shows an example TEM image of a SiNP-PANi composite electrode after 2,000 electrochemical cycles at low magnification, consistent with various aspects of the present disclosure;

FIG. 7B shows an example TEM image of a SiNP-PANi composite electrode after 2,000 electrochemical cycles at medium magnification, consistent with various aspects of the present disclosure;

FIG. 7C shows an example TEM image of a SiNP-PANi composite electrode after 2,000 electrochemical cycles at high magnification, consistent with various aspects of the present disclosure;

FIG. 8A shows example cell impedance tests of a SiNP-PANi composite electrode after each cycle, between cycles 1 and 10, consistent with various aspects of the present disclosure;

FIG. 8B shows example SEM images of a composite electrode after 2,000 electrochemical cycles, consistent with various aspects of the present disclosure;

FIG. 9 shows example results of cell impedance tests of SiNP-PANi composite electrode after 9, 100 and 200 deep cycles, consistent with various aspects of the present disclosure;

FIG. 10 shows an example photograph of a solution that contains ˜100 mM aniline monomer, and a solution that contains ˜30 mM phytic acid, consistent with various aspects of the present disclosure;

FIG. 11 shows an example three-dimensional conductive polymer gel containing Si nanoparticles, consistent with various aspects of the present disclosure;

FIG. 12A shows an example polymer matrix and synthesis featuring 3D conductive gels for dual function additives and binder material, consistent with various aspects of the present disclosure;

FIGS. 12B-D display SEM images at various levels of magnification of a polymer matrix, consistent with various aspects of the present disclosure;

FIG. 13 shows example experimental results of a Si nanoparticle/hydrogel composite electrode being cycled more than 1600 times without obvious capacity decay, consistent with various aspects of the present disclosure;

FIG. 14 shows an example magnified image of a Si nanoparticles-polypyrrole (PPy)hydrogel composite, consistent with various aspects of the present disclosure;

FIG. 15 shows another magnified image of a Si nanoparticles-polypyrrole (PPy) hydrogel composite, consistent with various aspects of the present disclosure;

FIG. 16 shows an example capacity curve of an Si polypyrrole (PPy) 50:50 electrode cycled at a rate of 3 C, consistent with various aspects of the present disclosure; and

FIG. 17 shows example data single >99% CE charge/discharge cycle, consistent with various aspects of the present disclosure.

While the disclosure is amenable to various modifications and alternative forms, specifics thereof have been shown by way of example in the drawings and will be described in detail. It should be understood, however, that the intention is not to limit the disclosure to the particular embodiments described. On the contrary, the intention is to cover all modifications, equivalents, and alternatives falling within the scope of the disclosure including aspects defined in the claims.

### DETAILED DESCRIPTION

The present disclosure is believed to be useful for applications involving energy storage devices and their use in a variety of applications. Aspects of the present disclosure have been found to be very useful and advantageous in applications involving various types of batteries and solar cells (e.g., thin film types), high-energy lithium ion batteries and components of batteries and solar cells. While the present disclosure is not necessarily limited to such applications, various aspects of the disclosure may be appreciated through a discussion of various examples using this context.

Various aspects of the present disclosure are directed toward energy storage devices, and methods of using and making such energy storage devices. Energy storage devices, consistent with various aspects of the present disclosure, include a source of lithium ions, a plurality of nanoparticles (or micro particles), and a conductive polymer network. The plurality of nanoparticles are each encapsulated in conductive polymer shells, and will volumetrically change due to lithiation and delithiation due to movement of the lithium ions created by an electrical potential. The conductive polymer network, consistent with various aspects of the present disclosure, bonds the nanoparticles and accommodates the volumetric changes of the nanoparticles during lithiation and delithiation.

In certain embodiments, the energy storage devices include at least one electrode formed from the plurality of nanoparticles and the conductive polymer network. In these embodiments, the electrode maintains at least an 80% charge capacity after 500 charging cycles. Additionally, in certain embodiments, the electrode maintains at least a 90% charge capacity after 500 charging cycles, and in certain more specific embodiments, 1000 charging cycles, or at least 5000 charging cycles. In certain other embodiments, the at least one electrode, which includes the plurality of nanoparticles and the conductive polymer network, maintains at least a 75% charge capacity after 500 charging cycles. The nanoparticles, in such an embodiment, can have an average diameter of approximately 100 nm, and in other embodiments, the diameter of the nanoparticles can be approximately 60 nm. Other embodiments of the energy devices that include an electrode, formed by the plurality of nanoparticles and the conductive polymer network, that has a gravimetric capacity at least of 1000 mAh/g. In these embodiments, the conductive polymer network includes dendritic nanofibers having diameters between 60 and 100 nm. Additionally, the conductive polymer network, in certain embodiments, includes pores that bond the nanoparticles, and in other embodiments, the conductive polymer network also includes carbon nanotubes, carbon nanofibers and/or graphene to increase the conductivity of the conductive polymer network.

Other embodiments of the present disclosure are further defined in that the conductive polymer network includes polyaniline (PANi) and derivatives of polyaniline (PANi). Additionally, the conductive polymer network can also include one or a combination of polyaniline (PANi) (and derivatives of PANi), polypyrrole (PPy) (and derivatives of PPy), PEDOT:PSS (and derivatives of PEDOT:PSS), poly (3,4-ethylenedioxythiophene poly(styrenesulfonate), and polythiophene derivatives. It is also possible that a conductive filler, such as carbon nanotubes, graphene, carbon nanofibers, metal particles or metal nano or microwires, are added into the conductive matrix.

The conductive polymer shells that encapsulate the nanoparticles, in certain embodiments of the present disclosure, include the material polyaniline (PANi). In other embodiments, the conductive polymer shells include the material polypyrrole (PPy). The conductive polymer shell can also be formed of a combination of polyaniline (PANi) and polypyrrole (PPy) (or the other polymers noted above). In certain more specific embodiments, the conductive polymer shells and the conductive polymer network both include the material polypyrrole (PPy). Additionally, in certain more specific embodiments, the conductive polymer shells and the conductive polymer network both include the material polyaniline (PANi). The nanoparticles that are encapsulated by the conductive polymer shells can be formed from silicon, germanium, tin, sulfur, alloys of silicon, alloys of tin or combinations thereof. Further, in certain embodiments, the conductive polymer shell facilitates growth of a deformable and stable solid-electrolyte interphase (SEI) on the nanoparticles.

Various aspects of the present disclosure are also directed toward energy storage devices that include a source of lithium ions, and at least one electrode that maintains at least an 80% charge capacity after 500 charging cycles, The electrode includes a plurality of nanoparticles, each of which are encapsulated in the conductive polymer shell. The material of the conductive polymer shell includes at least one of polyaniline (PANi), polypyrrole (PPY) and PEDOT. Additionally, the nanoparticles volumetrically change due to lithiation and delithiation as a result of movement of the lithium ions created by an electrical potential. The electrode also includes a conductive polymer network of at least one of polyaniline (PANi) and polypyrrole (PPy) and PEDOT. The conductive polymer network bonds the nanoparticles and accommodates volumetric changes of the plurality of nanoparticles during lithiation and delithiation. In certain embodiments, the conductive polymer network includes dendritic nanofibers having diameters between 60 and 100 nm, the conductive polymer network includes (PANi), and the conductive polymer shell is polyaniline (PANi).

Various aspects of the present disclosure are also directed towards methods such as for providing an anode for an energy storage device via solution phase synthesis. The methods can include synthesizing a conductive polymer network, encapsulating nanoparticles in conductive polymer shells, and then bonding the nanoparticles to the conductive polymer network. In certain specific embodiments, synthesizing the conductive polymer matrix includes providing a nanostructured polyaniline (PANi). Further, in certain embodiments, mechanically pressing the viscous gel occurs after providing the viscous gel on an electrode surface. Further, forming the conductive polymer matrix can be accomplished by in-situ polymerization. Moreover, in certain embodiments, the solution phase mixing occurs during the steps of providing the anode.

Various aspects of the present disclosure are directed toward a composite structure comprised of Si nanoparticles (SiNPs) confined within a 3D nanostructured polyaniline (PANi) conductive matrix fabricated via an in-situ polymerization process is disclosed. The Si-polyaniline (PANi) hydrogel composite electrodes are hierarchically assembled to form a highly porous 3D structure where the SiNPs are connected to each other and are also effectively wrapped inside the conductive polymer matrix. The resulting composite electrodes showed unprecedented electrochemical cycling performance, with >80% capacity retention after deep electrochemical cycling for 500 cycles in half cells.

Additionally, in certain embodiments, an electrode, including the plurality of nanoparticies and the conductive polymer network, maintains at least an 80% charge capacity after 1000 charging cycles, and in certain embodiments, 2000 charging cycles, 3000 charging cycles, 4000 charging cycles, and even 5000 charging cycles. Further, in certain embodiments, the nanoparticles have an average diameter of between 500-1000 nm.

Conductive polymer hydrogels are materials that offer advantageous features such as a 3D hierarchical porous conducting framework and excellent electronic and electrochemical properties. Conductive polymer hydrogels also exhibit superior electrochemical performance for use in supercapacitors and ultrasensitive biosensors. The 3D porous micro- and nano-structures of conductive polymer hydrogels can promote the transport of electrons and ions owing to the available short diffusion paths. Moreover, they can be synthesized by mixing two solutions, in which one contains the initiator (oxidizer) while the other contains the crosslinker and the monomer. For example, phytic acid, a natural occurring molecule consisting of six phosphoric acid groups, can be used as both the gelator and dopant to react with the aniline monomer through protonating the nitrogen groups on polyaniline (PANi), leading to the formation of a 3D interconnected network structure. In addition, since the Si nanoparticles are incorporated during the 3D hydrogel synthesis, they can be uniformly dispersed while the polymer forms effective interconnected conducting pathways.

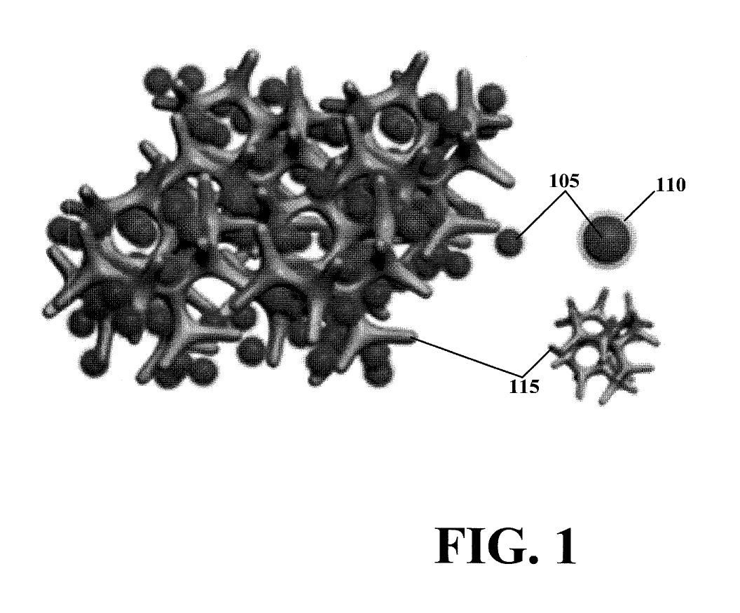

FIG. 1 shows an example schematic illustration of 3D porous nanoparticle/conductive polymer hydrogel composite electrodes, consistent with various aspects of the present disclosure. Each nanoparticle 105 is encapsulated within a conductive polymer surface coating 110, and is further connected to a conductive polymer network 115 that is a highly porous hydrogel framework. Each of the nanoparticles 105 volumetrically change due to lithiation and delithiation due to movement of the lithium ions created by an electrical potential. The conductive polymer network 115 bonds the nanoparticles 105 and accommodates the volumetric changes of the nanoparticles 105 during lithiation and delithiation.

An electrode, formed of the nanoparticle 105 is encapsulated within the conductive polymer surface coating 110 and the conductive polymer network 115, can maintain at least an 80% charge capacity after 500 charging cycles. In certain other embodiments, the at least one electrode, which includes the plurality of nanoparticles 105 and the conductive polymer network 115, maintains at least a 75% charge capacity after 500 charging cycles. The nanoparticles, in such an embodiment, can have an average diameter of approximately 60 nm. The electrode, formed by the plurality of nanoparticles 105 and the conductive polymer network 115, can have a gravimetric capacity at least of 1000 mAh/g. In these embodiments, the conductive polymer network 115 includes dendritic nanofibers having diameters between 60 and 100 nm. Additionally, the conductive polymer network 115, in certain embodiments, includes pores that bond the nanoparticles 105, and in other embodiments, the conductive polymer network 115 also includes carbon nanotubes, carbon nanofibers and/or graphene to increase the conductivity of the conductive polymer network 115.

Additionally, in certain embodiments, the at least one electrode, which includes the plurality of nanoparticles 105 and the conductive polymer network 115, maintains at least a 80% charge capacity after 1000 charging cycles, and in certain embodiments, 2000 charging cycles, 3000 charging cycles, 4000 charging cycles, and even 5000 charging cycles. Further, in certain embodiments, the nanoparticles 105 have an average diameter of anywhere between 50 and 1000 nm. Further, the conductive polymer network 115 can include dendritic nanofibers having diameters between 60 and 100 nm. Additionally, in certain embodiments, the at least one electrode, which includes the plurality of nanoparticles 105 and the conductive polymer network 115, has a gravimetric capacity at least of 500 mAh/g.

As discussed in further detail below, the conductive polymer network 115 can be formed of various different materials. For instance, the conductive polymer network 115 can include polyaniline (PANi) and derivatives of polyaniline (PANi). Additionally, the conductive polymer network 115 can also include one or a combination of polyaniline (PANi) (and derivatives of PANi), polypyrrole (PPy) (and derivatives of PPy), PEDOT:PSS (and derivatives of PEDOT:PSS), poly (3,4-ethylenedioxythiophene poly(styrenesulfonate), and polythiophene derivatives. It is also possible that a conductive filler, such as carbon nanotubes, graphene, carbon nanofibers, metal particles or metal nano or microwires, is added into the conductive matrix.

Similar to the conductive polymer network 115, and as discussed in further detail below, the conductive polymer shells 110 that encapsulate the nanoparticles 105 include the material polyaniline (PANi). In other embodiments, the conductive polymer shells 110 include the material polypyrrole (PPy). The conductive polymer shell 110 can also be formed of a combination of polyaniline (PANi) and polypyrrole (PPy) (or the other polymers noted above). In certain more specific embodiments, the conductive polymer shells 110 and the conductive polymer network 115 both include the material polypyrrole (PPy). Additionally, in certain more specific embodiments, the conductive polymer shells 110 and the conductive polymer network 115 both include the material polyaniline (PANi).

Further, the nanoparticles 105 that are encapsulated by the conductive polymer shells 115 can be formed from silicon, germanium, tin, sulfur, alloys of silicon, alloys of tin or combinations thereof. Further, in certain embodiments, the conductive polymer shell 115 facilitates growth of a deformable and stable SEI on the nanoparticles 105.

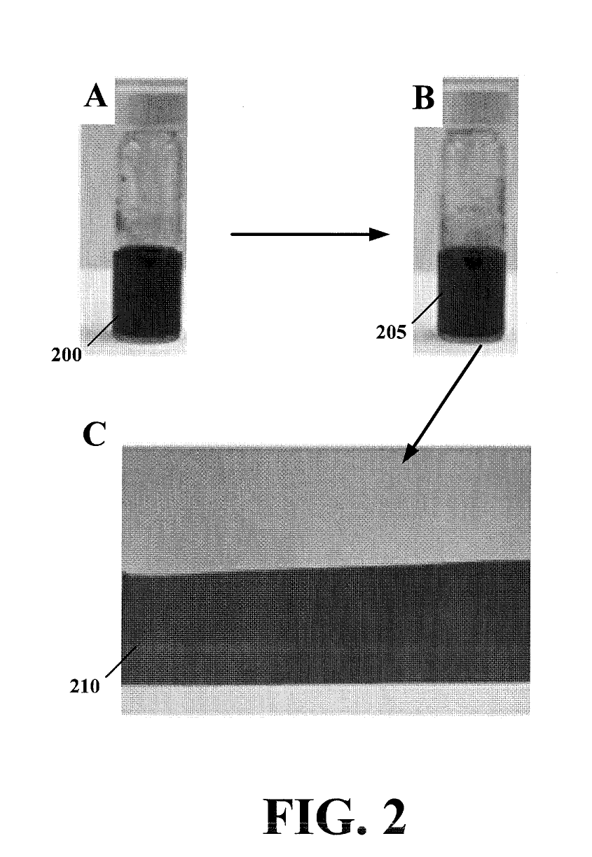

FIG. 2A shows an example step in an electrode fabrication process in which Si nanoparticles are dispersed in the hydrogel precursor solution, consistent with various aspects of the present disclosure. As is shown in FIG. 2A, a SiNP-PANi hydrogel composite, in certain embodiments, is fabricated via a scalable solution phase synthesis by mixing Si nanoparticles with phytic acid and aniline in water to give a brown suspension 200. FIG. 2B shows an example step in an electrode fabrication process in a viscous gel is formed, consistent with various aspects of the present disclosure. As is shown in FIG. 2B, within three minutes of adding an oxidizer (e.g., ammonium persulphate), the aniline rapidly polymerizes and crosslinks to result in a dark green and viscous gel 205 due to the presence of the phytic acid gelator. As is shown in FIG. 2C, a viscous gel is then bladed onto a copper foil current collector and dried to form a uniform film over a large area 210. FIG. 2C shows an example of a uniformly coated electrode film (5 cm×20 cm). This solution-based synthesis method and its compatibility with roll-to-roll coating methods makes the SiNP-PANi hydrogel composite readily scalable for large area electrode films. Subsequent to blading of the viscous gel, the SiNP-PANi hydrogel composite film can be mechanically pressed and thoroughly washed in deionized water to remove excess ions and oligomers, followed by vacuum drying overnight.

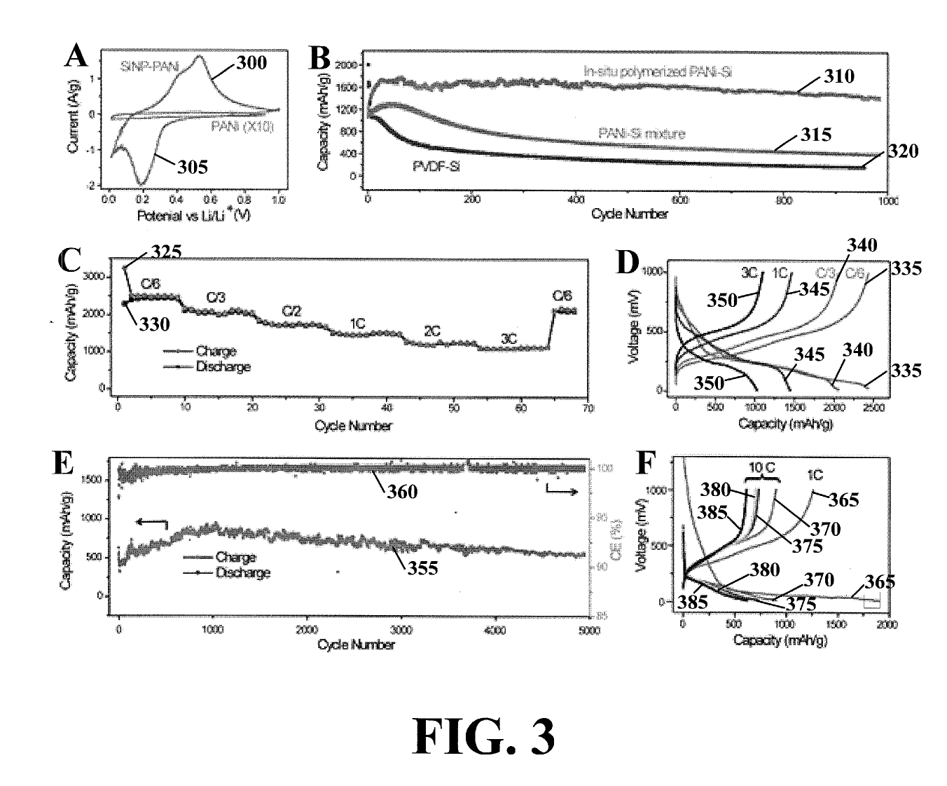

FIG. 3A shows example CV measurements of a SiNP-PANi hydrogel composite and a polyaniline (PANi) hydrogel, consistent with various aspects of the present disclosure. In FIG. 3A, the electrochemical properties of SiNP-PANi composite electrodes are characterized, CV measurements were performed on half cells at a scan rate of 0.05 mV/s over the potential window of 0.01 to 1 V vs. Li/Li⁺. As shown in FIG. 3A, the CV profile (SiNP-PANi curve 300) of a SiNP-PANi hydrogel composite electrode exhibits similar electrochemical characteristics to that of Si powders. The peak at 0.19 V in the cathodic process corresponds to the conversion of Si to the LiₓSi phase, while the two peaks at 0.41 and 0.53 V in the anodic process correspond to the delithiation of α-LiₓSi to α-Si. For comparison, the CV profile of a dried polyaniline (PANi) hydrogel film (curve 305) showed that the current density is about two orders of magnitude lower than that of the SiNP-PANi composite electrode, indicating negligible contribution from polyaniline (PANi) to the capacity of the whole electrode.

FIGS. 3B-F show example electrochemical cycling performance of the SiNP-PANi composite electrodes and how they are evaluated using deep charge/discharge galvanostatic cycling from 1 V to 0.01 V. FIG. 3B shows an example electrochemical cycling performance of the in-situ polymerized SiNP-PANi composite electrodes under deep charge/discharge cycles compared to two control samples, consistent with various aspects of the present disclosure. FIG. 3B shows an in-situ polymerized SiNP-PANi curve 310 against the two control sample curves, a PANi-Si mixture curve 315, and a PVDF-Si curve 320. FIG. 3C shows an example capacity of an Si nanoparticle/conductive polymer hydrogel composite electrode over 70 varying charge/discharge cycles, consistent with various aspects of the present disclosure. As shown in FIG. 3C, the capacity of a SiNP-PANi composite electrode varies from 2,500 mAh/g to 1,100 mAh/g at charge (curve 325) and discharge (curve 330) current densities ranging from 0.3 to 3 A/g (corresponding to C/6 and 3 C).

FIG. 3D shows example galvanostatic charge/discharge profiles of a SiNP-PANi electrode cycled at various rates from C/6 to 3 C, consistent with various aspects of the present disclosure. FIG. 3D shows charge/discharge profiles at C/6 (curve 335), C/3 (curve 340), 1 C (curve 345), and 3 C (curve 350). Further, as shown in FIG. 3D, even at a high rate of 3 C, the lithiation potential still shows a sloping profile between 0.3 and 0.01 V, which is consistent with the previously reported Li insertion to form amorphous LiₓSi. From this evidence, it can be concluded that Li ions can rapidly pass through the thin polyaniline (PANi) layer to reach the silicon active material even at very high charge/discharge rates.

FIG. 3E shows example graphs of lithiation/delithiation capacity and CE of a SiNP-PANi electrode cycled at 10 C for 5,000 cycles, consistent with various aspects of the present disclosure. FIG. 3E displays results that indicate a high current density of 6 A/g (or 10 C rate), an electrode capacity of ˜550 mAh/g is still retained after 5,000 cycles (as is shown by charge curve 355 and discharge curve 360), which results in ˜91% capacity retention. This is in sharp contrast to conventional graphite anodes, which yield only <100 mAh/g at such a high current. FIG. 3F shows example galvanostatic charge/discharge profiles plotted for the 1^{st} (365), 1,000^{th} (370), 2,000^{th} (375) 3,000^{th} (380), and 4,000^{th} (385) cycles, consistent with various aspects of the present disclosure. As is shown in FIG. 3F, there is no obvious change in the charge capacity or charge/discharge profile that can be found after 5,000 cycles for the Si-PANi hybrid anode, indicating its superior and stable cycling performance.

High coulombic efficiency (CE) is required for practical silicon-based electrodes. For Si-PANi hydrogel composite electrodes, consistent with various aspects of the present disclosure, the CE of the first cycle was ˜70%. SEI formation consumes a certain percentage of the lithium. Surprisingly, the average CE of the Si-PANi hydrogel composite electrode from the 2nd to 5,000th cycle is 99.8%. The achieved high CE is due in part to the formation of a stable SEI on the composite electrode. The electrochemical cycling measurements shown in FIGS. 3B-F were conducted at room temperature in two-electrode 2032 coin-type half-cells. All specific capacities are reported based on the weight of the Si nanoparticles.

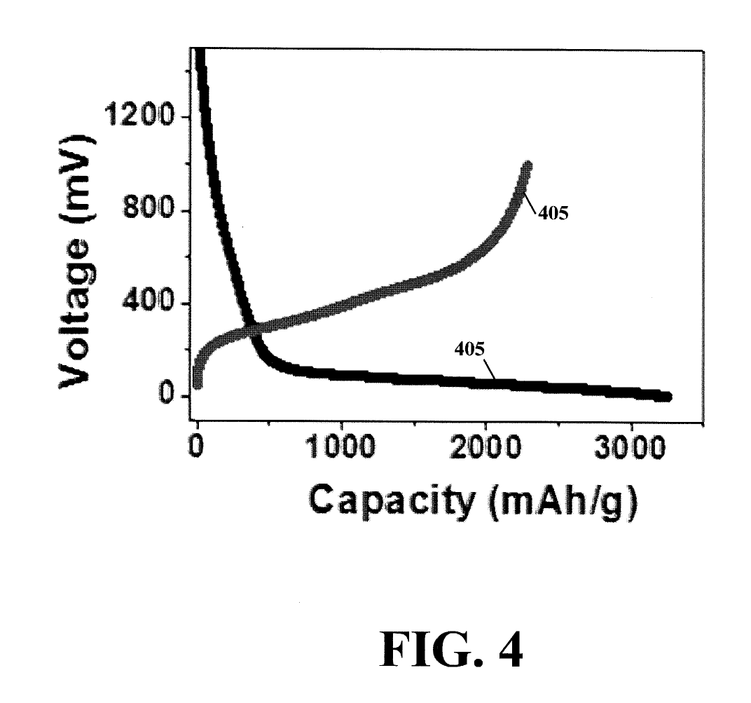

FIG. 4 shows an example voltage profile of the first charge/discharge galvanostatic cycle of a SiNP-PANi composite electrode at a slow rate of C/5, consistent with various aspects of the present disclosure. As evidenced in FIG. 4, the first charge (curves 405) has a long plateau at around 0.1 V, which corresponds to the lithiation potential of pure crystalline silicon from the SiNPs. At a charge/discharge current of 1 A/g, the SiNP-PANi composite electrode exhibits a relatively stable reversible lithium capacity of 1,600 mAh/g for 1,000 deep cycles. In comparison, the Si nanoparticle electrode using traditional polyvinylidene fluoride (PVDF) binder loses more than 50% of its initial capacity after being cycled only 100 times. With regard to the SiNP-PANi composite electrodes, the continuous conducting polymer hydrogel frameworks, which are directly connected to the current collector, provide channels for fast electron transport, enabling outstanding rate capability.

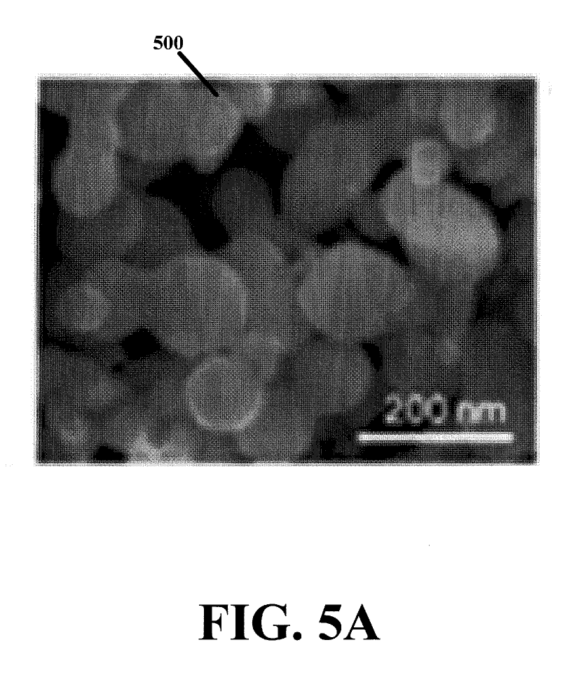

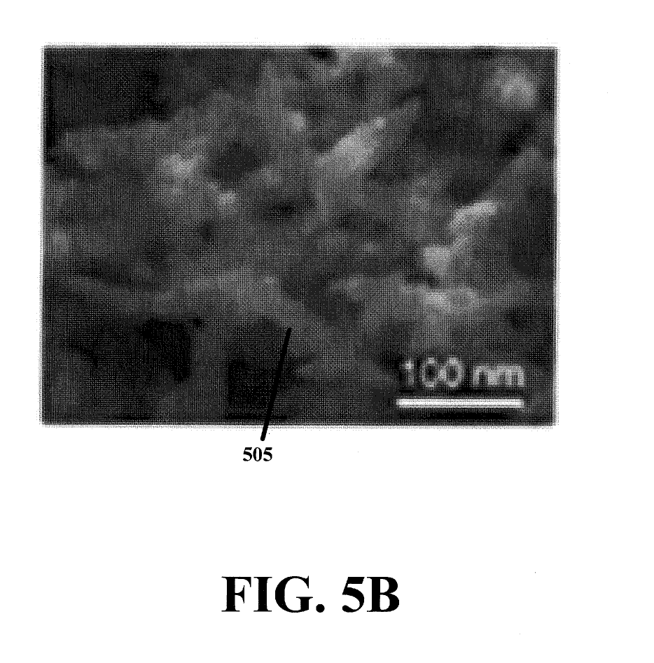

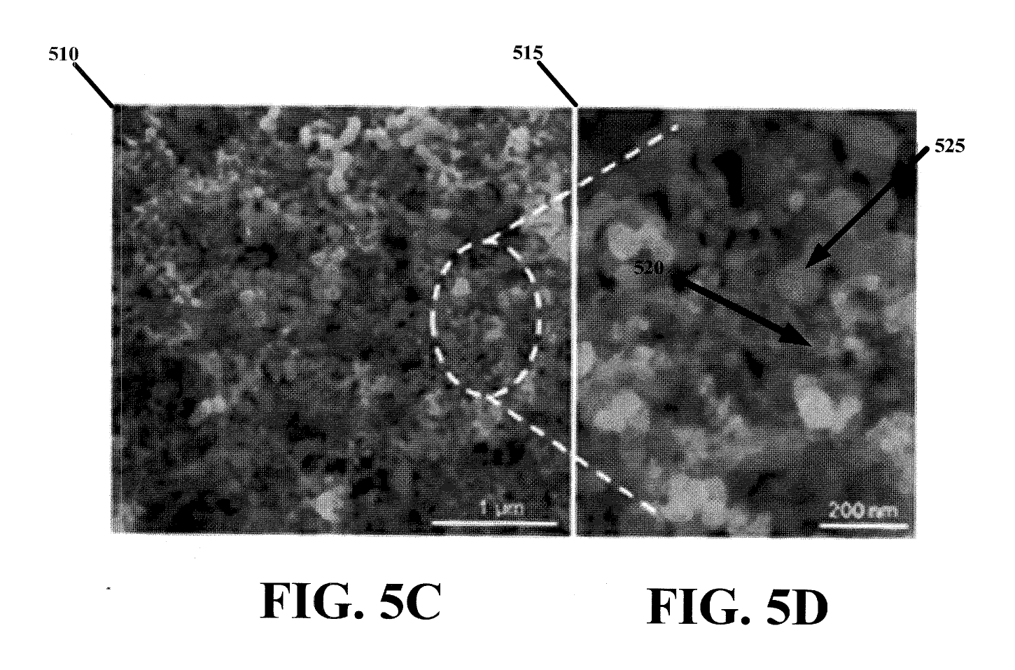

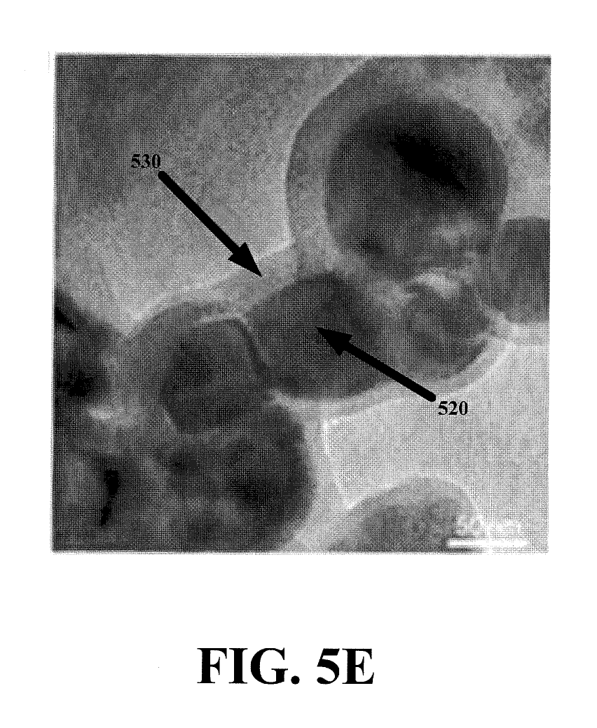

FIG. 5A shows an example scanning electron microscope (SEM) image of pure Si nanoparticles 500 and FIG. 5B shows an example SEM image of a polyaniline (PANi) hydrogel sample 505, consistent with various aspects of the present disclosure. The spherical silicon nanoparticles 500, in certain embodiments, have an average diameter of ˜60 nm, while the dried polymer hydrogel 505 consists of a hierarchical 3D porous foam-like network composed of dendritic nanofibers with diameters of 60 to 100 nm.

FIGS. 5C and 5D shows an example SEM image of a SiNP-PANi composite electrode at low 510 and high magnifications 515, consistent with various aspects of the present disclosure. The electrochemical performance of Si-PANi hydrogel composite electrodes can be attributed to the advantageous features offered by the microstructure. Because the polyaniline (PANi) was formed in the presence of SiNPs 520, the SiNPs 520 are in intimate contact to the conductive polymer hydrogel matrix 525 at both the microscopic and molecular level, as confirmed by SEM images of the composite electrode shown in FIG. 5C. FIG. 5C also evidences a uniform mixture of SiNPs 520 embedded inside the highly porous polymer matrix 525.

FIG. 5E shows an example TEM image showing Si nanoparticles coated with a uniform PANi polymer layer, consistent with various aspects of the present disclosure. As shown in FIG. 5D, SiNPs 520 appear encapsulated by a conformal polyaniline (PANi) polymer layer 530, as shown in the TEM image. The conformal polyaniline (PANi) surface coating can be formed due to the in-situ polymerization of aniline monomer onto the surface of the Si particles, since the negatively charged hydroxyl groups of the surface oxide on SiNPs can potentially have electrostatic interactions with the positively charged polyaniline (PANi) as a result of the phytic acid dopant.

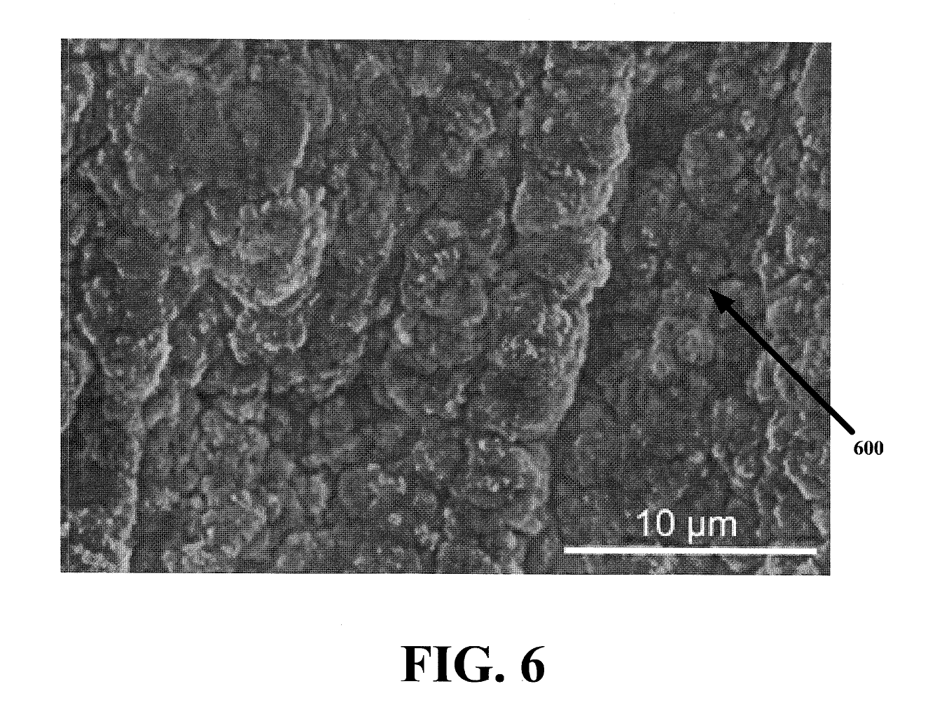

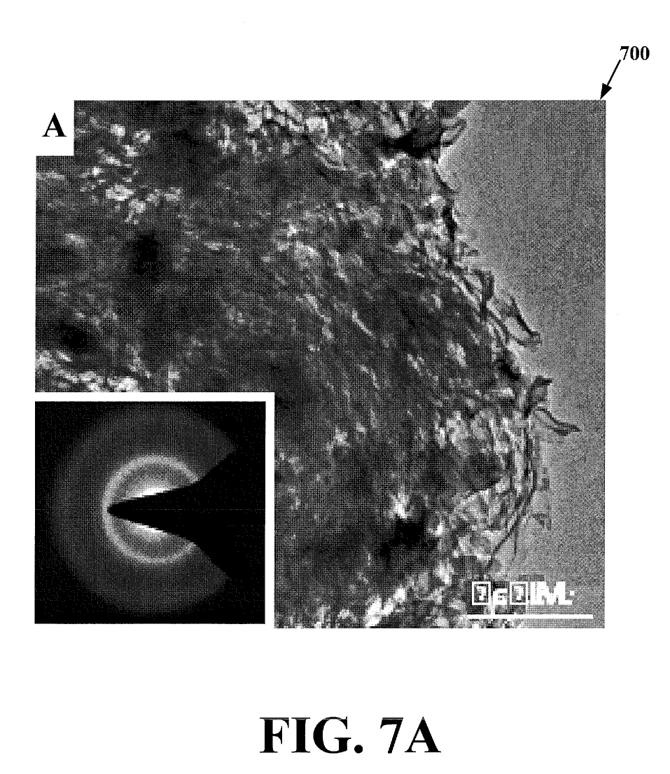

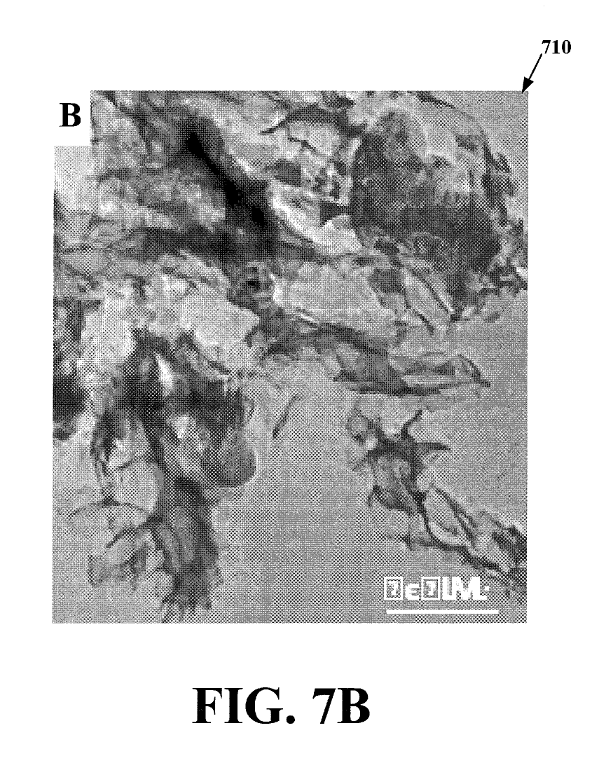

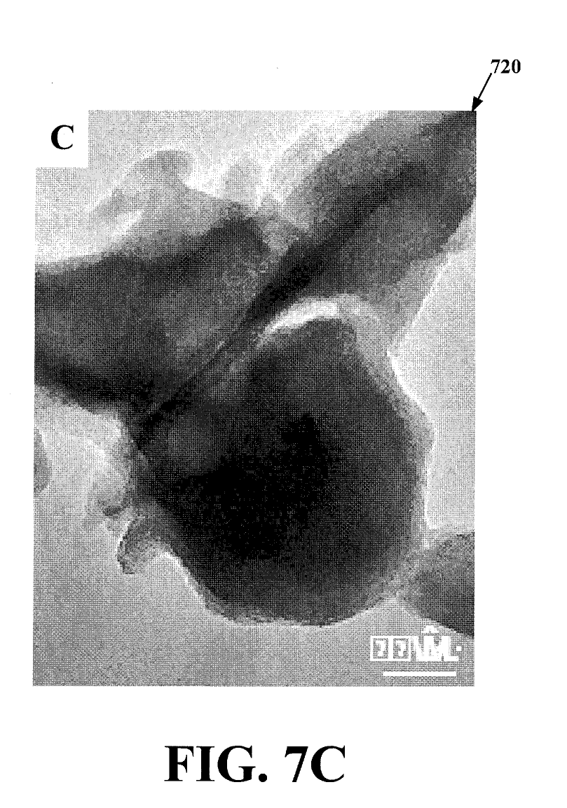

The nanoscale architecture of the Si-PANi composite electrode contributes to the demonstrated electrochemical stability. In certain embodiments, a porous hydrogel matrix has empty space to allow for the large volume expansion of the SiNPs during lithium insertion. Further, the highly conductive and continuous 3D polyaniline (PANi) framework, as well as the conformal conductive coating surrounding each SiNP, can provide electrical connection to the particles. Moreover, although pulverization of larger particles may still occur during lithiation and battery cycling, the fractured Si pieces are trapped within the interconnected narrow pores of the polymer matrix, which maintains electrical connectivity. FIG. 6 and FIG. 7 show confirmation of the polymer matrix after cycling.

FIG. 6 shows an example series of SEM images of a Si nanoparticle electrode with PVDF binder after 2,000 cycles, consistent with various aspects of the present disclosure. Even though the polymer surface coating on the particles break upon initial volume expansion during lithiation, the coating still enables the SiNPs connected to the conductive matrix 600.

FIGS. 7A-C show example TEM images of SiNP-PANi composite electrode after 2,000 electrochemical cycles at low magnification 700, medium magnification 710, and high magnification 720, consistent with various aspects of the present disclosure.

To further confirm the stabilizing effect of the in-situ polymerized polyaniline (PANi) coating, a control electrode was fabricated by mixing pre-synthesized polyaniline (PANi) hydrogel and SiNPs. In this control sample, a similar weight ratio of the SiNPs to the polyaniline (PANi) hydrogel composite structure was used, but there was no intimate surface coating on the Si particles since the aniline precursor had already been polymerized prior to mixing. The electrochemical cycling of this control sample is shown in FIG. 3B. Even though this system showed a better cycling stability than the bare SiNPs electrode with PVDF binder, lower capacity retention than the in-situ polymerized PANi-SiNP composite electrode was obtained.

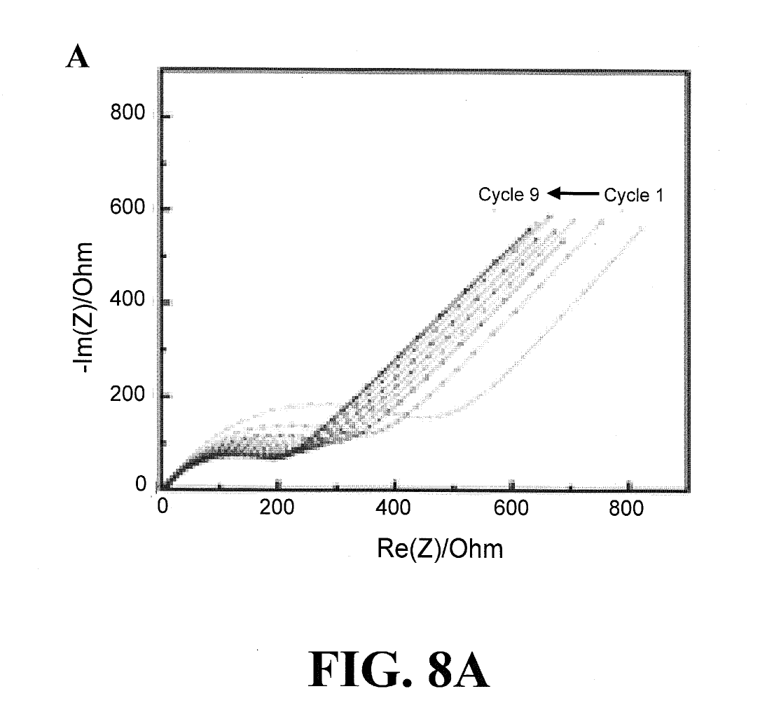

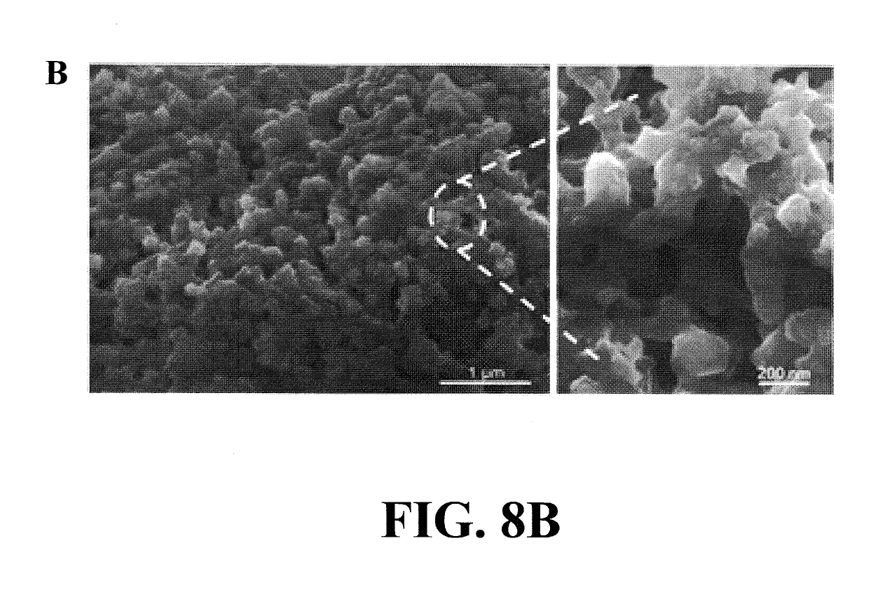

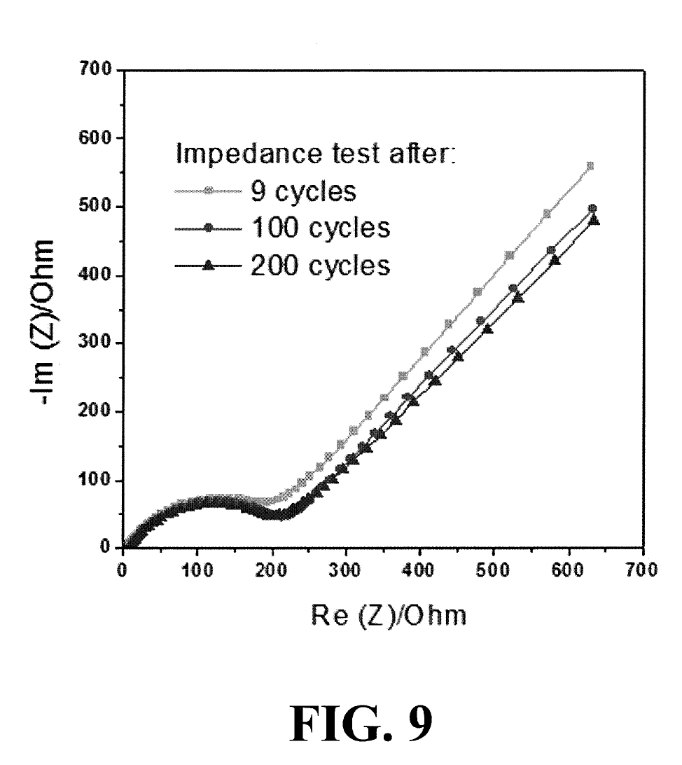

FIG. 8A shows example cell impedance tests of a SiNP-PANi composite electrode after each cycle, between cycles 1 and 10, consistent with various aspects of the present disclosure. FIG. 8B shows example SEM images of a composite electrode after 2,000 electrochemical cycles, consistent with various aspects of the present disclosure. The uniform polyaniline (PANi) coating on the Si particles also assisted in enabling a deformable and stable SEI on the SiNP surface. Cell impedance measurements of the PANi-SiNP composite electrode after cycles 1 to 10 and 10 to 200, shown in FIG. 8A and FIG. 9 respectively, evidence no obvious impedance increase, indicating limited growth of the SEI during cycling.

As shown in FIG. 8B, SEM images of composite electrodes after 2000 electrochemical cycles confirm that a uniform and thin SEI formed on the electrode, resulting in the cycling performance. In comparison, in FIG. 6, the SEM image evidences very thick SEI layer growth on SiNP electrodes with traditional PVDF binders after 2000 electrochemical cycles. The formation of a thin and stable SEI, in the PANi-SiNP composite electrodes, could be attributed to the modification of the Si surface by the in-situ polymerization of polyaniline (PANi), similar to the polar hydrogen bonds between carboxyl groups of some binders and SiO₂. The stable SEI formation on the PANi-SiNP composite electrodes is directly responsible for the long cycle life, as well as the high CE in the half cell battery tests.

FIG. 9 shows example results of cell impedance tests of a SiNP-PANi composite electrode after 9, 100, and 200 deep cycles, consistent with various aspects of the present disclosure.

Accordingly, various embodiments of the present disclosure are directed to a facile and scalable solution process to fabricate high performance Li-ion negative electrodes by encapsulating Si nanoparticles in a 3D porous nanostructured conductive polymer framework. The conductive polymer matrix is used in such embodiments to provide fast electronic and ionic transfer channels as well as free space for Si volume changes, for achieving high capacity and extremely stable electrochemical cycling. In specific embodiments, the electrode can be continuously deep cycled up to 5,000 times without significant capacity decay, and the solution synthesis and electrode fabrication process is highly scalable and compatible with existing slurry coating battery manufacturing technology. These advancements are applicable to high performance composite electrodes and for permitting them to be readily scaled up for manufacturing next generation high-energy Li-ion batteries, as used in applications including electric vehicles and grid-scale energy storage systems that require both low-cost and reliable battery systems. In addition, certain of these embodiments and related aspects and materials as designed for silicon-based anodes can be extended to other battery electrode materials systems that experience large volume expansion and unstable SEI formation during cycling.

### EXPERIMENTAL DISCUSSION AND EMBODIMENTS

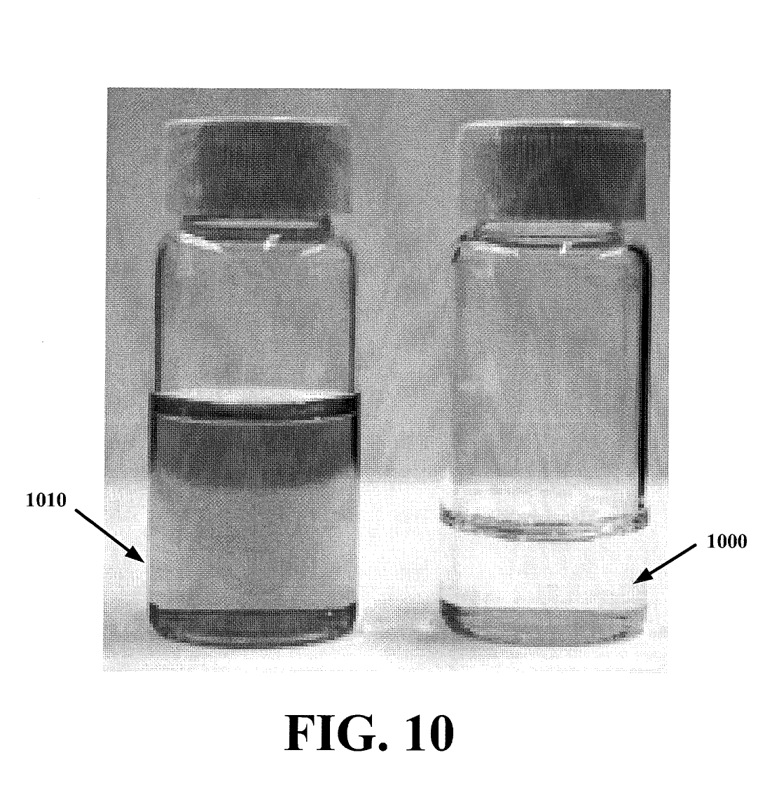

In certain more specific embodiments, composite SiNP-PANi hydrogel electrodes, consistent with various aspects of the present disclosure, can be made via the following solution processes. FIG. 10 shows an example photograph of a solution that contains ˜100 mM aniline monomer (1000), and a solution that contains ˜30 mM phytic acid, consistent with various aspects of the present disclosure. A volume, for example, 0.9 ml, of Solution A 1000 (100 mM aniline monomer and ˜30 mM phytic acid) is added and mixed with Si nanoparticles (e.g., 80 mg). A volume, for example, 0.3 ml, of Solution B (1010) containing 125 mM ammonium persulfate is added into the above mixture and subjected to ˜1 mM bath sonication. After approximately 3 minutes, the solution changes color from brown to dark green and becomes viscous and gel-like, indicating in-situ polymerization of aniline monomer to form the SiNP-PANi hydrogel.

A SiNP-PANi hydrogel electrode, consistent with various aspects of the present disclosure, can be made by doctorblading the viscous SiNP-PANi hydrogel onto a Cu foil current collector and drying at room temperature. The SiNP-PANi hydrogel composite film is then mechanically pressed and thoroughly washed in deionized water several times to remove excess phytic acid, and the composite electrode film is dried in vacuum at room temperature. The mass loading is around 0.2 mg/cm². The polyaniline (PANi) hydrogel-only control samples are made via the same process by mixing the two solutions (Solution A and Solution B) without SiNPs added in.

Alloy type Li-ion battery anode materials like Silicon, Germanium, Tin and some cathode materials like sulfur have very high specific capacities for strong lithium ions at suitable voltages. For example the theoretical capacity of silicon (4200 mAh/g) is 10 times higher than that of graphite anode (˜370 mAh/g). However, the large volumetric expansion of these materials upon insertion and extraction of lithium causes the materials to pulverization and prevents their practical applications. In addition, these alloy-based anode materials can suffer from unstable SEI formation associated with large volume changes, resulting in low CE and capacity loss during battery cycling.

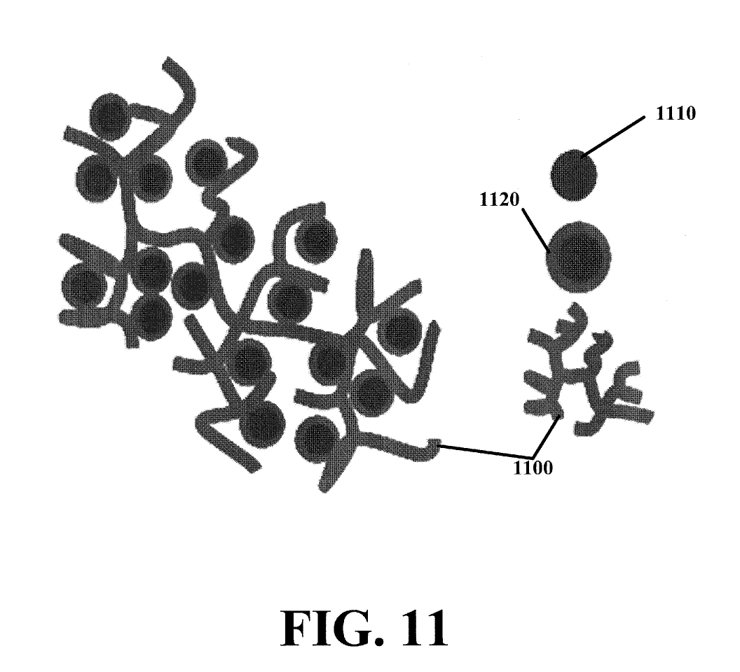

FIG. 11 shows an example 3D conductive polymer gel containing Si nanoparticles (or micro particles), consistent with various aspects of the present disclosure. A 3D conductive polymer gel 1100 incorporates Si nanoparticles 1110 to form SiNP-PANi hydrogel electrodes. The 3D conductive polymer gel 1100 is flexible and facilitates synthesis enabled by the polymer chemistry which allows the highly scalable solution-phase processing, and enables uniform conductive polymer coating 1120 on Si nanoparticles 1110. Further, interconnected conductive polymer chain networks formed during in-situ polymerization provide a continuous electron transport framework, allowing the effective electron collection on current collector for good rate performance and high capacity of the resulting electrodes. Moreover, hierarchical porous gel structures can accommodate large volume change of Si anodes during lithiation/delithiation process. The active material is not limited to silicon. Consistent with various aspects of the present disclosure, high energy anode materials such as Sn and Ge can be used as an active material, as can cathode materials such as sulfur.

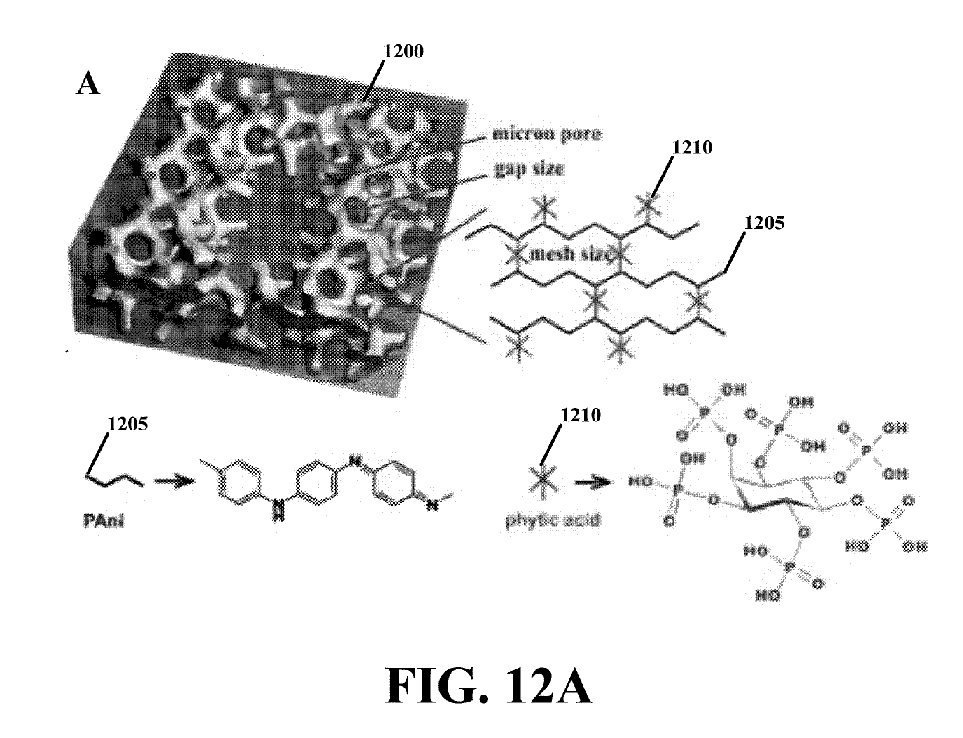

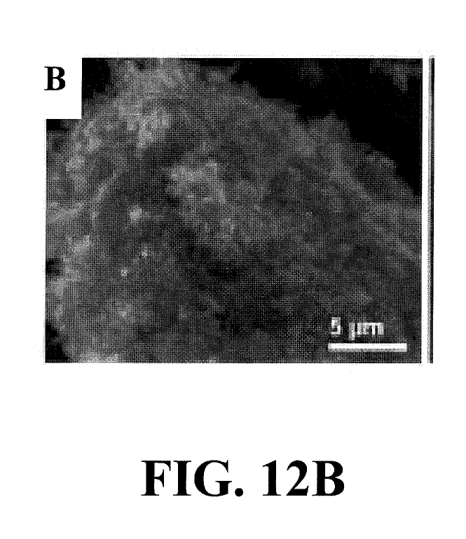

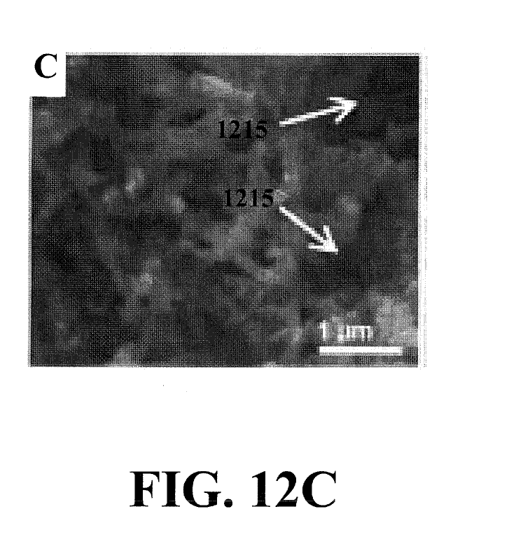

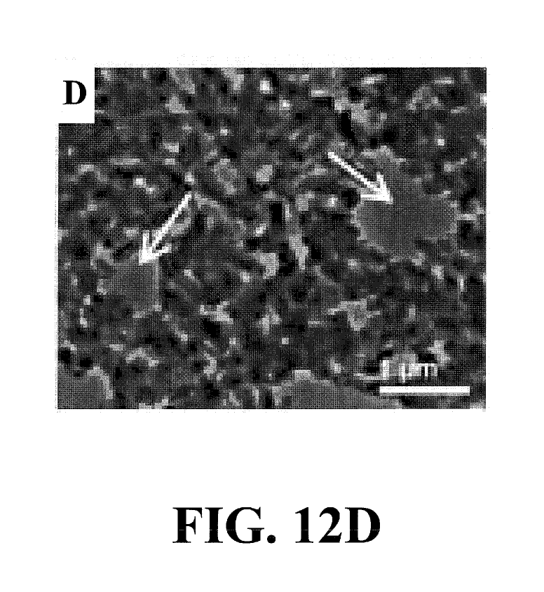

FIG. 12A shows an example polymer matrix including 3D conductive gels for dual function additives and binder material, consistent with various aspects of the present disclosure. A 3D rendering of the structure of the polymer matrix 1200 is shown with a basic breakdown of the chemical components, as well as the molecular geometry of the chemical components. The structure of the polymer matrix 1200 is composed of a plurality of PaNi branches 1205 with phytic acid 1210 connecting the PaNi branches 1205. The molecular geometry of the PaNi branches 1205 and the phytic acid 1210 is shown at the bottom portion of FIG. 12A. As shown in FIG. 12A, the polymer matrix, consistent with various aspects of the present disclosure, functions as conductive additives and binder materials. The polymer matrix is highly cross-linked (as is shown by the PaNi branches 1205 crosslinked with phytic acid 1210), which forms an interconnected 3D nanostructured conductive framework with a hierarchical porosity for accommodation of volume changes (as is illustrated by the micron pores and gap sizes). FIGS. 12B-D display SEM images at various levels of magnification of a polymer matrix, which also display some of the many features of SiNP-PANi hydrogel electrodes including pores 1215 that provide hierarchical porosity inside the gel and accommodates large volume changes of SiNPs during battery cycles. Further, the SiNP-PANi hydrogel electrodes, can include the matrix shown in FIG. 12A, and consistent with various aspects of the present disclosure, are formed by in-situ polymerization, which allows for the formation of uniform conductive polymer coatings on SiNPs and an interconnected polymer matrix which acts as a continuous electron transport framework. Further, the matrix, shown in FIG. 12A, is formed by all solution-processed-scalable, environmentally friendly synthesis (no chemical vapor deposition (CVD) or high temperature annealing involved in the process).

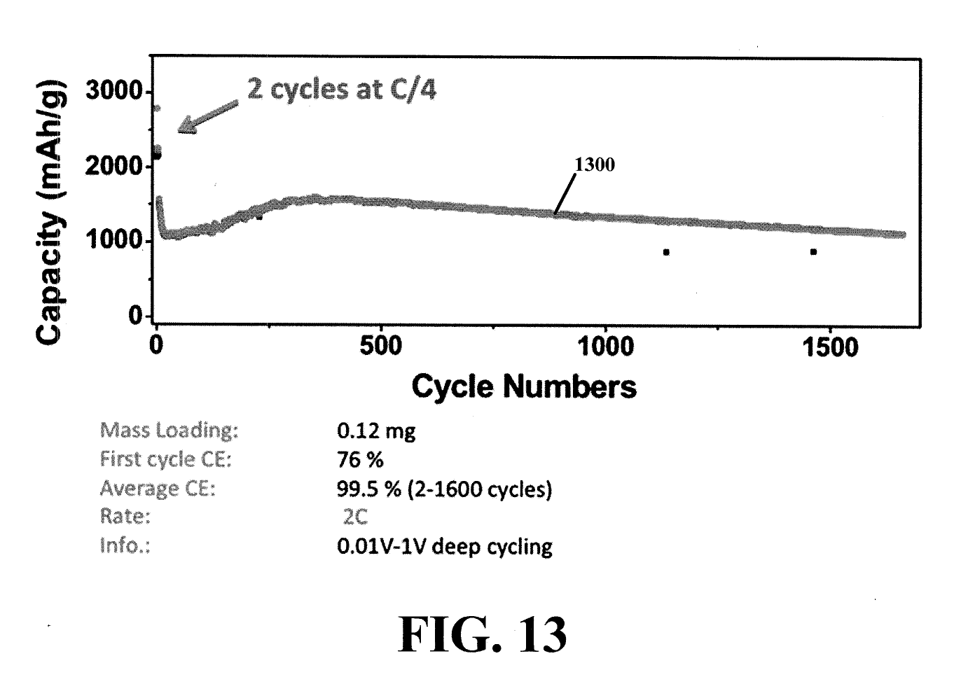

FIG. 13 shows example experimental results of a Si nanoparticle/hydrogel composite electrode being cycled more than 1600 times without obvious capacity decay, consistent with various aspects of the present disclosure. The experimental data shown in FIG. 13 indicates that a SiNP-PANi hydrogel composite electrode, consistent with various aspects of the present disclosure, has a capacity of >1000 mAh/g, and can be cycled for more than 1600 times without obvious capacity decay (curve 1300).

Various aspects of the present disclosure are also directed toward Si/PPy composite materials for use as electrodes. The Si/PPy composite material can be formed, for example, using a 0.9 ml solution that contains 0.4 M pyrrole monomer and 0.1 M phytic acid solution (50% w/w in H₂O) in IPA. This solution is mixed with 80 mg silicon nanoparticles, then bath sonicated to form the mixture. A 0.3 ml solution that includes, as example, 0.5 M ammonium persulphate (initiator) in deionized water, is added into the first solution and subjected to ˜5 minute bath sonication to produce a homogeneous Si-Polypyrrole hydrogel mixture. After approximately 10 minutes, the solution changes color from brown to black, and becomes viscous and gel-like, indicating in-situ polymerization of pyrrole monomer to form the PPy hydrogel. The Si/PPy composite material is bladed onto a copper foil current collector, and dried at room temperature in a fume hood for 3 hours, and then immersed under deionized water for 10 hours to completely remove excess phytic acid in the electrode. The composite electrode film is then dried in vacuum at room temperature. The electrode material loading is 0.2˜0.3 mg/cm².

The electrochemical properties can be examined by galvanostatic cycling of coin-type half cells with the SiNP-PANT hydrogel composite as the working electrode and lithium foil as the counter/reference electrode. The electrolyte for all tests was 1 M LiPF₆ in ethylene carbonate/diethylcarbonate/vinylene carbonate (1:1:0.02 v/v/v), and separators.

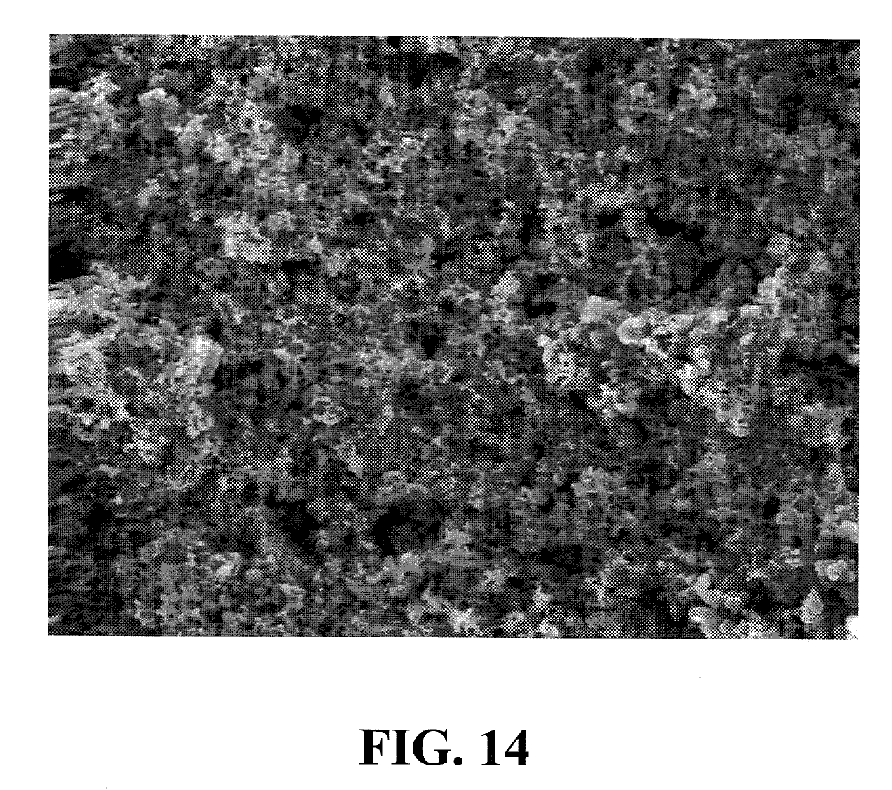

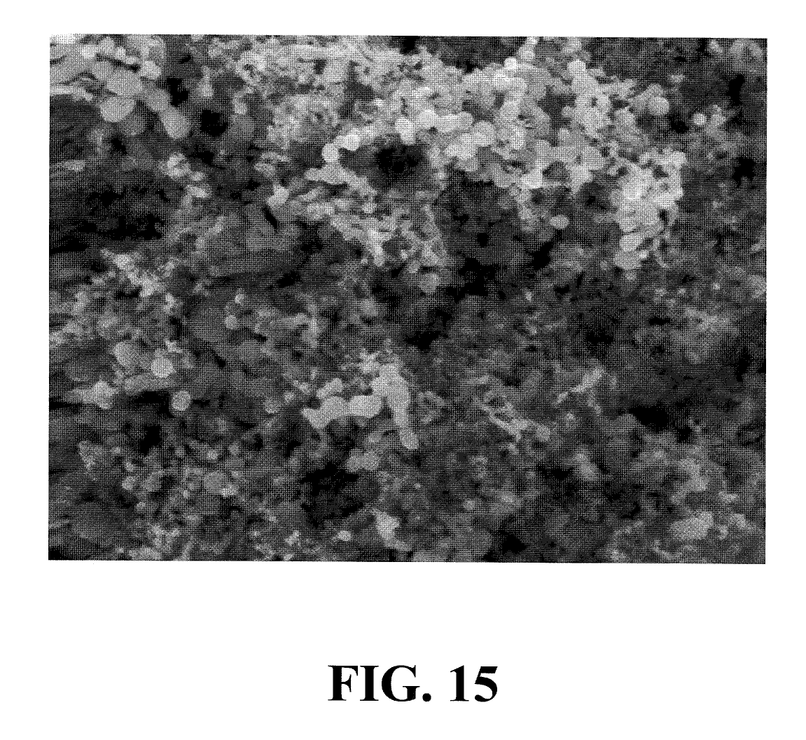

FIG. 14 and FIG. 15 show example magnified images of a Si nanoparticles-PPy hydrogel composite, consistent with various aspects of the present disclosure. A Si nanoparticles-PPy hydrogel composite, consistent with various aspects of the present disclosure, can be used as electrodes similar to the Si-PANi hydrogel composite electrodes as described above. Si nanoparticles-PPy hydrogel composite electrodes also have fast charge/discharge times. For instance, an example Si nanoparticles-PPy hydrogel composite electrode demonstrated a charge/discharge 3 C for 3000 cycles, with greater than 2,000 mAh/g capacity remaining.

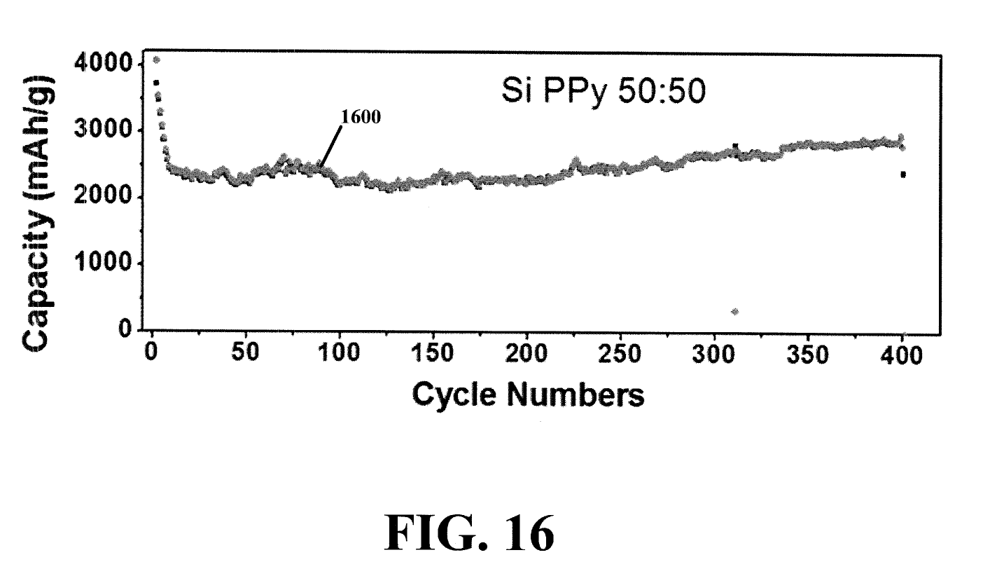

FIG. 16 shows an example capacity curve of an Si PPy 50:50 electrode cycled at a rate of 3 C, consistent with various aspects of the present disclosure. The capacity curve 1600 shown in FIG. 16 is an Si PPy 50:50 electrode cycled 400 times at a rate of 3 C. The first cycle being a CE of 66%, with the following cycles >99% CE. The cycling was between 0.01 V and 1V (filly charge/discharge). The electrolyte used was: EC/DEC/2% FEC.

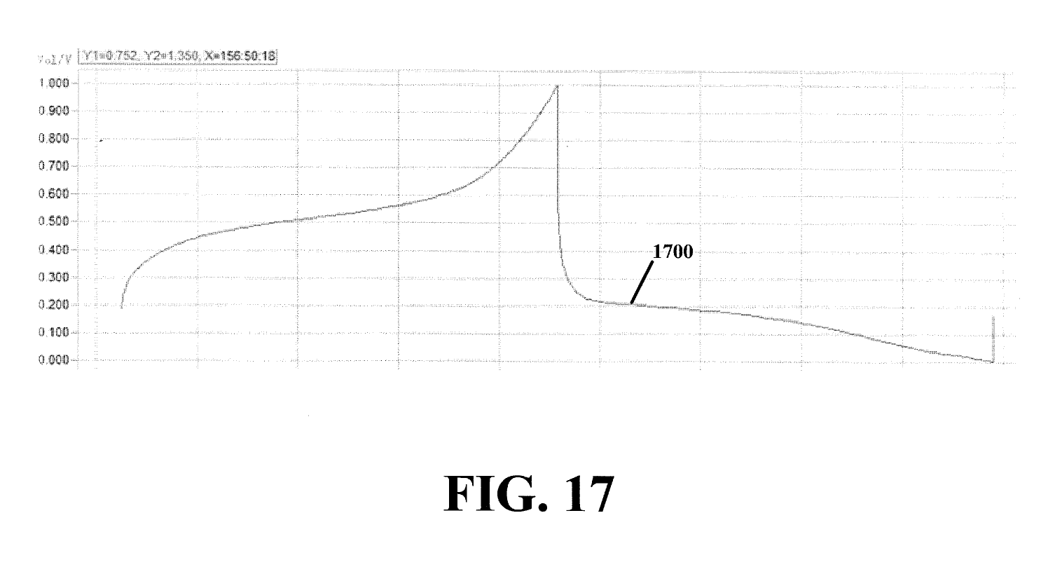

FIG. 17 shows example data single greater than 99% CE charge/discharge cycle, consistent with various aspects of the present disclosure. FIG. 17 depicts the >99% CE charge/discharge cycle 1700 used in the data of FIG. 16. The result, the Si PPy 50:50 electrode of FIG. 16 maintained >2.00 mAh/g capacity after over 200 cycles at 3 C.

For further discussion of conductive polymer hydrogels that bond to and accommodate volumetric changes in nanoparticles encapsulated in a conductive material, as relating to the embodiments and specific applications discussed herein, reference may be made to the underlying U.S. Provisional Patent Applications, Ser. No. 61/681,395 filed on Aug. 9, 2012, and Ser. No. 61/785,333 filed on Mar. 14, 2013 (including the Appendices therein) to which priority is claimed. The aspects discussed therein may be implemented in connection with one or more of embodiments and implementations of the present disclosure (as well as with those shown in the figures). Moreover, for general information and for specifics regarding applications and implementations to which one or more embodiments of the present disclosure may be directed to and/or applicable, reference may be made to the references cited in the aforesaid patent application and published article, which are fully incorporated herein by reference generally and for the reasons noted above. In view of the description herein, those skilled in the art will recognize that many changes may be made thereto without departing from the spirit and scope of the present disclosure.

Based upon the above discussion and illustrations, those skilled in the art will readily recognize that various modifications and changes may be made without strictly following the exemplary embodiments and applications illustrated and described herein. Furthermore, various features of the different embodiments may be implemented in various combinations. Such modifications do not depart from the true spirit and scope of the present disclosure, including those set forth in the following claims.

What is claimed is:

1. An energy storage device comprising:
a source of lithium ions;
a plurality of nanoparticles, each being encapsulated in conductive polymer shells, configured and arranged to volumetrically change due to lithiation and delithiation due to movement of the lithium ions created by an electrical potential; and
a conductive polymer network configured and arranged to bond the nanoparticles and accommodate volumetric changes of the plurality of nanoparticles during lithiation and delithiation.

2. The device of claim 1, further including at least one electrode including the plurality of nanoparticles and the conductive polymer network, the at least one electrode being configured and arranged to maintain at least a 80% charge capacity after 500 charging cycles.

3. The device of claim 1, further including at least one electrode including the plurality of nanoparticles and the conductive polymer network, the at least one electrode being configured and arranged to maintain at least a 80% charge capacity after 1000 charging cycles, and wherein the nanoparticles have an average diameter of approximately 100 nm.

4. The device of claim 1, further including at least one electrode including the plurality of nanoparticles and the conductive polymer network, the at least one electrode being configured and arranged with a gravimetric capacity at least of 1000 mAh/g, and wherein the conductive polymer network includes dendritic nanofibers having diameters between 60 and 100 nm.

5. The device of claim 1, further including at least one electrode including the plurality of nanoparticles and the conductive polymer network, and wherein the conductive polymer network includes polyaniline (PANi) and derivatives of polyaniline (PANi), and the at least one electrode is configured and arranged to maintain at least a 80% charge capacity after 2000 charging cycles.

6. The device of claim 1, further including at least one electrode including the plurality of nanoparticles and the conductive polymer network, and wherein the conductive polymer shell is polyaniline (PANi), and the at least one electrode is configured and arranged to maintain at least a 80% charge capacity after 3000 charging cycles.

7. The device of claim 1, further including at least one electrode including the plurality of nanoparticles and the conductive polymer network, the at least one electrode being configured and arranged to maintain at least a 80% charge capacity after 5000 charging cycles, and wherein the nanoparticles have an average diameter of between 100-500 nm, and the conductive polymer shell is polyaniline (PANi), and the conductive polymer network includes polyaniline (PANi).

8. The device of claim 1, wherein the conductive polymer network includes at least one of polyaniline (PANi) and derivatives of polyaniline (PANi), polypyrrole (PPy) and derivatives of polypyrrole (PPy), PEDOT:PSS and derivatives of PEDOT:PSS, poly (3, 4-ethylenedioxythiophene poly(styrenesulfonate), and polythiophene derivatives.

9. The device of claim 1, further including at least one electrode including the plurality of nanoparticles and the conductive polymer network, the at least one electrode being configured and arranged with a gravimetric capacity at least of 500 mAh/g, and wherein the conductive polymer network includes dendritic nanofibers having diameters between 60 and 100 nm, and the conductive polymer shell is polypyrrole (PPy).

10. The device of claim 1, further including at least one electrode including the plurality of nanoparticles and the conductive polymer network, and wherein the conductive polymer shell is polypyrrole (PPy), and the conductive polymer network includes PPy.

11. The device of claim 1, wherein the nanoparticles include one or more of silicon, germanium, tin, sulfur, alloys of silicon, and alloys of tin.

12. The device of claim 1, wherein pores in the conductive polymer network are configured and arranged to bond the nanoparticles, and the conductive polymer network further includes at least one of carbon nanotubes, carbon nanofiber, metal nano and microparticles, metal nano and microwires and graphene.

13. The device of claim 1 wherein the conductive polymer shell facilitates growth of a deformable and stable solid-electrolyte interphase (SEI) on the nanoparticles.

14. A method comprising:
providing an anode for an energy storage device via solution phase synthesis which includes
synthesizing a conductive polymer network;
encapsulating nanoparticles in conductive polymer shells; and
bonding the nanoparticles to the conductive polymer network.

15. The method of claim 14, wherein the step of synthesizing the conductive polymer network includes providing a nanostructured polyaniline (PANi).

16. The method of claim 14, wherein the step of synthesizing the conductive polymer network includes providing a viscous gel of a solution, including the nanoparticles and the conductive polymer network, on an electrode surface and mechanically pressing the viscous gel thereafter.

17. The method of claim 14, further including a step of forming the conductive polymer network by in-situ polymerization.

18. The method of claim 14, further including a step of solution phase mixing.

19. An energy storage device comprising:
a source of lithium ions;
at least one electrode configured and arranged to maintain at least a 80% charge capacity after 500 charging cycles, the electrode having
a plurality of nanoparticles, each being encapsulated in conductive polymer shells of at least one of polyaniline (PANi), polypyrrole (PPY) and PEDOT, configured and arranged to volumetrically change due to lithiation and delithiation in response to movement of the lithium ions created by an electrical potential, and
a conductive polymer network of at least one of polyaniline (PANi) and polypyrrole (PPY) and PEDOT, the conductive polymer network being configured and arranged to bond the nanoparticles and accommodate volumetric changes of the plurality of nanoparticles during lithiation and delithiation.

20. The energy storage device of claim 19, wherein the conductive polymer network includes dendritic nanofibers having diameters between 60 and 100 nm, the conductive polymer network includes (PANi), and the conductive polymer shell is polyaniline (PANi).
